(19) United States
(12) Patent Application Publication
(10) Pub. No.: US 2013/0170583 A1
(43) Pub. Date: Jul. 4, 2013

(54) TRANSMITTING SYSTEM, RECEIVING SYSTEM, TRANSMITTING METHOD, AND RECEIVING METHOD

(71) Applicants: Kiyotaka Ichiyama, Tokyo (JP); Masahiro Ishida, Tokyo (JP)

(72) Inventors: Kiyotaka Ichiyama, Tokyo (JP); Masahiro Ishida, Tokyo (JP)

(73) Assignee: ADVANTEST CORPORATION, Tokyo (JP)

(21) Appl. No.: 13/615,463

(22) Filed: Sep. 13, 2012

(30) Foreign Application Priority Data
Dec. 28, 2011 (JP) 2011-288096

(51) Int. Cl. H04L 27/04; H04L 27/06

(52) U.S. Cl. 375/300; 375/268

(57) ABSTRACT

Provided are a transmitting system including a pulse amplitude modulator section that pulse amplitude modulates an input signal into a set of first and second pulse amplitude modulated signals, a first frequency signal output section that outputs a first frequency signal, a first amplitude shift keying modulator section that amplitude shift keying modulates, using the first frequency signal, the first pulse amplitude modulated signal into an amplitude shift keying modulated signal, an adder section that adds together the amplitude shift keying modulated signal and the second pulse amplitude modulated signal to generate a transmission signal, and a transmitter section that transmits the transmission signal, a transmitting method, a receiving system for receiving the signal transmitted from the transmitting system and a receiving method.

### BACKGROUND

1. Technical Field

The present invention relates to a transmitting system, a receiving system, a transmitting method, and a receiving method.

2. Related Art

In the conventional art, digital data has been transmitted and received using techniques such as quadrature amplitude modulation (QAM), orthogonal frequency division multiplexing (OFDM), Amplitude Shift Keying (ASK), and Pulse Amplitude Modulation (PAM) as disclosed in, for example, Japanese Patent Application Publications Nos. 2005-160042, 2004-104257, 09-322130, and 11-239189.

The communication techniques utilizing phase orthogonality such as QAM employ double side band (DSB) modulation and demodulation and thus need at least twice as wide a communication band as the symbol rate. In addition, OFDM can achieve a double data rate when compared with QAM when the communication band is the same but requires complex transmitter and receiver since it utilizes not only phase orthogonality but also frequency orthogonality. On the other hand, ASK and PAM adopt single side band (SSB) modulation and demodulation and thus can perform transmission and reception utilizing the communication band similar to the symbol rate. ASK and PAM, however, have a lower data rate than OFDM and the like. Thus, it has been difficult to achieve high-speed data communication with simple configuration using a limited communication band similar to a symbol rate.

### SUMMARY

Therefore, it is an object of an aspect of the innovations herein to provide a transmitting system, a receiving system, a transmitting method and a receiving method, which are capable of overcoming the above drawbacks accompanying the related art. The above and other objects can be achieved by combinations described in the claims. A first aspect of the innovations may include a transmitting system including a pulse amplitude modulator section that pulse amplitude modulates an input signal into a set of first and second pulse amplitude modulated signals, a first frequency signal output section that outputs a first frequency signal, a first amplitude shift keying modulator section that amplitude shift keying modulates, using the first frequency signal, the first pulse amplitude modulated signal into a amplitude shift keying modulated signal, an adder section that adds together the amplitude shift keying modulated signal and the second pulse amplitude modulated signal to generate a transmission signal, and a transmitter section that transmits the transmission signal. A transmitting method, a receiving system for receiving the signal transmitted from the transmitting system and a receiving method are also provided.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 illustrates an exemplary configuration of a transmitting system 100 and a receiving system 500 relating to an embodiment of the present invention, together with a transfer line 10.

FIG. 2 illustrates an exemplary configuration of an integrator section 600 relating to an embodiment of the present invention.

FIG. 3 illustrates, as an example, simulation results of the operations of integrators included in the integrator section 600 relating to an embodiment of the present invention.

FIG. 4 is an eye diagram showing simulation results of output signals from the integrators included in the integrator section 600 relating to an embodiment of the present invention.

FIG. 5 illustrates, as an example, simulation results of data transmission and reception using OFDM.

FIG. 6 illustrates, as an example, simulation results of data transmission and reception using OFDM when the receiving timing is different from expectation.

FIG. 7 illustrates, as an example, simulation results of data transmission and reception using the transmitting system 100 and the receiving system 500 relating to an embodiment of the present invention.

FIG. 8 illustrates, as an example, simulation results of data transmission and reception using the transmitting system 100 and the receiving system 500 relating to an embodiment of the present invention when the receiving timing is different from expectation.

FIG. 9 illustrates a first modification example of the transmitting system 100 and the receiving system 500 relating to the embodiment of the present invention, together with the transfer line 10.

FIG. 10 illustrates a second modification example of the transmitting system 100 and the receiving system 500 relating to the embodiment of the present invention, together with the transfer line 10.

FIG. 11 illustrates a third modification example of the transmitting system 100 and the receiving system 500 relating to the embodiment of the present invention, together with the transfer line 10.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

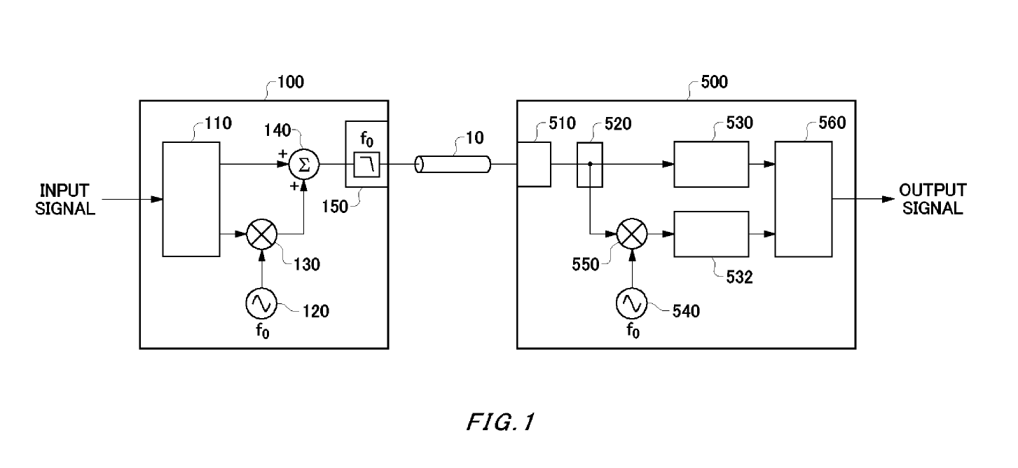

FIG. 1 illustrates an exemplary configuration of a transmitting system 100 and a receiving system 500 relating to an embodiment of the present invention, together with a transfer line 10. The transmitting system 100 and the receiving system 500 relating to the present embodiment achieves an improved data rate for data transmission and reception with a limited communication band similar to a symbol rate by orthogonal frequency multiplexing the results of pulse amplitude modulation and amplitude shift keying.

The transmitting system 100 transmits a transmission signal to the receiving system 500 via the transfer line 10. The transmission signal is obtained by multiplexing a pulse amplitude modulated signal that has been obtained by pulse amplitude modulating data input into the transmitting system 100 and an amplitude shift keying modulated signal that has been obtained by amplitude shift keying modulating the pulse amplitude modulated signal. The transmitting system 100 includes a pulse amplitude modulator section 110, a first frequency signal output section 120, a first amplitude shift keying modulator section 130, an adder section 140, and a transmitter section 150.

The pulse amplitude modulator section 110 pulse amplitude modulates an input signal into a set of a first pulse amplitude modulated signal and a second pulse amplitude modulated signal. The pulse amplitude modulator section 110 encodes the amplitude of the input signal at every symbol period into a series of pulse signals. For example, when using two bits for the modulation, the pulse amplitude modulator section 110 classifies the input signal into 4 codes (4 PAM). For example, the pulse amplitude modulator section 110 classifies, at every symbol period, the voltage amplitude of the input signal into one of 4 voltages such as −1.5 V, −0.5 V, 0.5 V and 1.5 V, which respectively correspond to codes of [00], [01], [10] and [11].

The pulse amplitude modulator section 110 may first divide one input signal into two signals at every predetermined bit length and then pulse amplitude modulate the respective signals into two pulse amplitude modulated signals. Alternatively, the pulse amplitude modulator section 110 may pulse amplitude modulate two different input signals into two pulse amplitude modulated signals.

The first frequency signal output section 120 outputs a first frequency signal f₀. The first frequency signal output section 120 outputs a signal having a predetermined frequency. For example, the first frequency signal output section 120 outputs a frequency signal having the same period as the symbol period with which the pulse amplitude modulator section 110 performs the pulse amplitude modulation. Alternatively, the first frequency signal output section 120 may output a frequency signal having a period equal to or shorter than the symbol period. In this case, the first frequency signal output section 120 may output a frequency signal the period of which is a fraction of 1/n of the symbol period, where n is a natural number equal to or greater than 1.

The first amplitude shift keying modulator section 130 is connected to the pulse amplitude modulator section 110 and amplitude shift keying modulates the first pulse amplitude modulated signal with the use of the first frequency signal into an amplitude shift keying modulated signal. The first amplitude shift keying modulator section 130 includes a mixer and may amplitude modulate the first pulse amplitude modulated signal output from the pulse amplitude modulator section 110 with the use of the first frequency signal into an amplitude shift keying modulated signal.

The adder section 140 is connected to the first amplitude shift keying modulator section 130 and the pulse amplitude modulator section 110, and adds together the amplitude shift keying modulated signal output from the first amplitude shift keying modulator section 130 and the second pulse amplitude modulated signal output from the pulse amplitude modulator section 110 into a transmission signal. The adder section 140 sends the generated transmission signal to the transmitter section 150.

The transmitter section 150 is connected to the adder section 140 and transmits the transmission signal received from the adder section 140 to the receiving system 500 via the transfer line 10. The transmitter section 150 may include a connecter that is configured to fit with the transfer line 10 and be connected to the transfer line 10. The transmitter section 150 may include a low-pass filter to allow the signal band of the transmission signal to pass. For example, the transmitter section 150 includes a low-pass filter that allows a frequency signal to pass having a frequency equal to or lower than f₀, which is the frequency of the first frequency signal.

The receiving system 500 receives and demodulates the transmission signal that has been transmitted from the transmitting system 100. The receiving system 500 includes a receiver section 510, a divider section 520, a first integrator section 530, a second integrator section 532, a frequency signal output section 540, a first amplitude shift keying demodulator section 550, and a pulse amplitude demodulator section 560.

The receiver section 510 receives the transmission signal that has been transmitted from the transmitting system 100. The receiver section 510 may include a connector configured to fit with the transfer line 10 and be connected to the transfer line 10. The receiver section 510 may include a low-pass filter to allow the signal band of a reception signal to pass. For example, the receiver section 510 includes a low-pass filter to at least allow a frequency signal to pass having a frequency equal to or lower than f₀, which is the frequency of the first frequency signal.

The divider section 520 is connected to the receiver section 510 and divides the transfer path configured to transfer the reception signal that has been received by the receiver section 510 into two transfer branches. The first integrator section 530 is connected to the divider section 520 and integrates the signal transmitted from the divider section 520.

The first integrator section 530 is connected to one of the two transfer branches provided by the divider section 520 and integrates the reception signal over a predetermined duration at every symbol period with which the pulse amplitude modulator section 110 performs the pulse amplitude modulation, to generate the pulse amplitude modulated signal. The first integrator section 530 may include a plurality of integrators as described later. For example, the first integrator section 530 integrates the reception signal over substantially the same duration as the symbol period.

For example, when the first amplitude shift keying modulator section 130 performs the amplitude shift keying modulation using a frequency signal having the same period as the symbol period, the first integrator section 530 integrates the reception signal over the same duration as the symbol period so that the amplitude shift keying modulated signal is averaged at every modulation period and the integral value of the signal becomes zero. Therefore, the first integrator section 530 can output the integral value of the second pulse amplitude modulated signal by integrating the reception signal that has been generated by adding together the amplitude shift keying modulated signal and the second pulse amplitude modulated signal.

The frequency signal output section 540 outputs a frequency signal having substantially the same frequency f₀ as the first frequency signal. The first amplitude shift keying demodulator section 550 is connected to the other of the transfer branches provided by the divider section 520 and amplitude shift keying demodulates the reception signal with the use of a signal having substantially the same frequency as the first frequency signal into a demodulated signal. The first amplitude shift keying demodulator section 550 may include a mixer and demodulate the reception signal using a frequency substantially the same as the frequency of the first frequency signal output from the frequency signal output section 540.

In this way, the first amplitude shift keying demodulator section 550 can demodulate, from among the reception signal generated by adding together the amplitude shift keying modulated signal and the second pulse amplitude modulated signal, the component of the amplitude shift keying modulated signal using the frequency f₀ that is substantially the same as the frequency of the first frequency signal. Thus, the first amplitude shift keying demodulator section 550 can obtain the first pulse amplitude modulated signal. Furthermore, the first amplitude shift keying demodulator section 550 mixes the component of the second pulse amplitude modulated signal with the first frequency, so that the component of the second pulse amplitude modulated signal is amplitude modulated by the first frequency signal.

In other words, the first amplitude shift keying demodulator section 550 outputs a signal generated by multiplexing the component of the demodulated first pulse amplitude modulated signal and the component of the second pulse amplitude modulated signal that has been amplitude modulated by the first frequency signal.

The second integrator section 532 is connected to the first amplitude shift keying demodulator section 550 and integrates the demodulated signal over a predetermined duration at every symbol period to generate a pulse amplitude modulated signal. The second integrator section 532 may include a plurality of integrators similarly to the first integrator section 530 as described later. For example, the second integrator section 532 integrates the demodulated signal over substantially the same duration as the symbol period, similarly to the first integrator section 530.

In this way, since the second integrator section 532 integrates the demodulated signal with the period of the first frequency, which is equal to the symbol period, the second integrator section 532 averages, from among the received demodulated signal, the component of the second pulse amplitude modulated signal that has been amplitude modulated using the first frequency signal so that the integral value of the component of the second pulse amplitude modulated signal becomes zero. Therefore, the second integrator section 532 integrates the received signal generated by multiplexing the amplitude shift keying modulated signal and the second pulse amplitude modulated signal to output the integral value of the first pulse amplitude modulated signal.

The pulse amplitude demodulator section 560 is connected to the first integrator section 530 and the second integrator section 532, receives the pulse amplitude modulated signals respectively output from the first integrator section 530 and the second integrator section 532 and perform pulse amplitude demodulation on the received signals. For example, the pulse amplitude demodulator section 560 analog/digital converts and acquires the signals respectively received from the first and second integrator sections 530 and 532. Thus, the pulse amplitude demodulator section 560 converts the signals into voltage amplitude values such as −1.5 V, −0.5 V, 0.5 V and 1.5 V corresponding to the codes of [00], [01], [10] and [11] generated by the pulse amplitude modulator section 110 at every symbol period.

As described above, the transmitting system 100 and the receiving system 500 relating to an embodiment of the present invention can transmit and receive a signal without using phase orthogonality and with the use of a combination of PAM and ASK. Stated differently, the transmitting system 100 and the receiving system 500 can achieve double the data rate while using substantially the same communication band as the symbol rate. Consequently, the present embodiment can achieve high-speed data communication using a limited communication band with a simple configuration. The transmitting system 100 and the receiving system 500 relating to the present embodiment can achieve an improved throughput (bit rate/bandwidth) when compared with the currently used digital communication techniques. In addition, the communication techniques of the present embodiment can be easily implemented onto LSIs and the like.

In the present exemplary embodiment, the receiving system 500 includes the frequency signal output section 540 that is configured to output substantially the same frequency as the first frequency signal. Here, the transmitting system 100 may transmit the first frequency signal to the receiving system 500 in advance, and the frequency signal output section 540 may output a frequency signal that has substantially the same frequency as the first frequency signal and has been synchronized with the received first frequency signal.

Alternatively, the receiving system 500 may receive the first frequency signal from the transmitting system 100 through a transfer line different from the transfer line 10. Stated differently, the first amplitude shift keying demodulator section 550 performs the amplitude shift keying demodulation using the first frequency signal output from the first frequency signal output section 120 of the transmitting system 100. In this way, the receiving system 500 may be realized without the frequency signal output section 540.

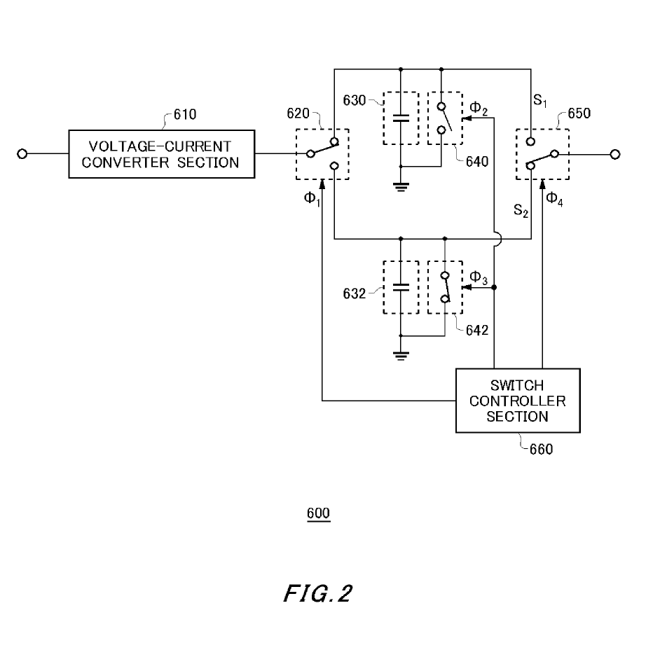

FIG. 2 illustrates an exemplary configuration of an integrator section 600 relating to an embodiment of the present invention. The integrator section 600 may be used as the first integrator section 530 and the second integrator section 532 included in the receiving system 500 described above with reference to FIG. 1. The integrator section 600 employs an interleaving technique utilizing two or more integrators, and integrates the input signal over substantially the same duration as the symbol period at every symbol period with it being possible to eliminate the dead band time for retaining the integrated data.

In other words, each of the integrators included in the integrator section 600 switches, at every symbol period, between the operation of integrating the input signal and the operation of retaining the integral value, so that while one of the integrators is performing the operation of integrating the input signal, the other one or more integrators perform the operation of retaining the integral values. In the integrator section 600, one of the integrators is connected to the output end of the integrator section 600 while the one integrator is retaining the integral value, and the other one or more integrators are connected to the output end of the integrator section 600 while the other integrators are retaining the integral values. In this way, the integrator section 600 integrates the input signal over substantially the same duration as the symbol period at every symbol period while outputting the integrated data through the output end of the integrator section 600. In this example, the integrator section 600 is assumed to include two integrators.

The integrator section 600 includes a voltage-current converter section 610, a first switch 620, a first integrator 630, a second integrator 632, a second switch 640, a third switch 642, a fourth switch 650 and a switch controller section 660. The voltage-current converter section 610 converts the voltage of the input signal into a current. The voltage-current converter section 610 transmits the resulting current to the first switch 620.

The first switch 620 is connected to the voltage-current converter section 610, and transmits the received current to one of the first integrator 630 and the second integrator 632 according to a control signal by switching the transfer path. The first switch 620 may be a single-input double-output switch.

The first integrator 630 is connected to one of the outputs of the first switch 620, and receives and integrates the current signal transmitted from the voltage-current converter section 610. The first integrator 630 transmits the integrated current signal to the fourth switch 650. For example, the first integrator 630 includes a capacitor one of the ends of which is connected to one of the outputs of the first switch 620 and the other end of which is connected to the ground (GND), so that the first integrator 630 accumulates electrical charges according to the input current signal and transmits a current signal corresponding to the accumulated electrical charges to the fourth switch 650.

The second switch 640 is connected to both of the ends of the first integrator 630, and connects one of the ends of the first integrator 630 to the other end according to a control signal to release the electrical charges accumulated in the first integrator 630 to the ground. In other words, the second switch 640 resets the first integrator 630 according to the control signal.

The second integrator 632 is connected to the other of the outputs of the first switch 620, and receives and integrates the current signal transmitted from the voltage-current converter section 610. The second integrator 632 transmits the integrated current signal to the fourth switch 650. For example, the second integrator 632 includes a capacitor one of the ends of which is connected to the other of the outputs of the first switch 620, and the other end of which is connected to the ground (GND). In this way, the second integrator 632 accumulates electrical charges according to the input current signal and transmits a current signal according to the accumulated charges to the fourth switch 650.

The third switch 642 is connected to both of the ends of the second integrator 632, and connects one of the ends of the second integrator 632 to the other end according to a control signal to release the electrical charges accumulated in the second integrator 632 to the ground. In other words, the third switch 642 resets the second integrator 632 according to the control signal.

The fourth switch 650 is connected to the first integrator 630 and the second integrator 632, and outputs one of the integrated signals output from the first integrator 630 and the second integrator 632 according to a control signal by switching the transfer path. The fourth switch 650 may be a double-input single-output switch.

The switch controller section 660 is connected to the first to fourth switches and transmits control signals to switch the respective switches. For example, to enable the first integrator 630 to integrate the input signal, the switch controller section 660 transmits, to the first switch 620, a control signal Φ₁ designed to switch the first switch 620 in order to connect the voltage-current converter section 610 to the first integrator 630. Here, to enable the first integrator 630 to integrate the input signal, the switch controller section 660 transmits to the second switch 640 a control signal Φ₂ to switch the second switch 640 to disconnect the connection between one of the ends of the first integrator 630, the other end, and the ground.

When the second integrator 632 has already integrated the input signal, the switch controller section 660 transmits to the fourth switch 650 a control signal Φ₄ to switch the fourth switch 650 while the first integrator 630 integrates the input signal, and thus allow the integrated signal to be output by connecting the second integrator 632 to the output end of the integrator section 600. After the second integrator 632 has output the integrated signal, the switch controller section 660 transmits to the third switch 642 a control signal Φ₃ to switch the third switch 642 and thus resets the second integrator 632 by connecting one of the ends of the second integrator 632 and the other end of the second integrator 632.

Subsequently, the switch controller section 660 allows the second integrator 632 to integrate the input signal. While the second integrator 632 is integrating the input signal, the switch controller section 660 allows the integrated signal integrated by the first integrator 630 to be output from the output end of the integrator section 600. The switch controller section 660 repeats the above-described cycle to allow the first integrator 630 and the second integrator 632 to integrate the input signal over a predetermined duration at every predetermined period and allows the integrated signal to be output from the output end of the integrator section 600.

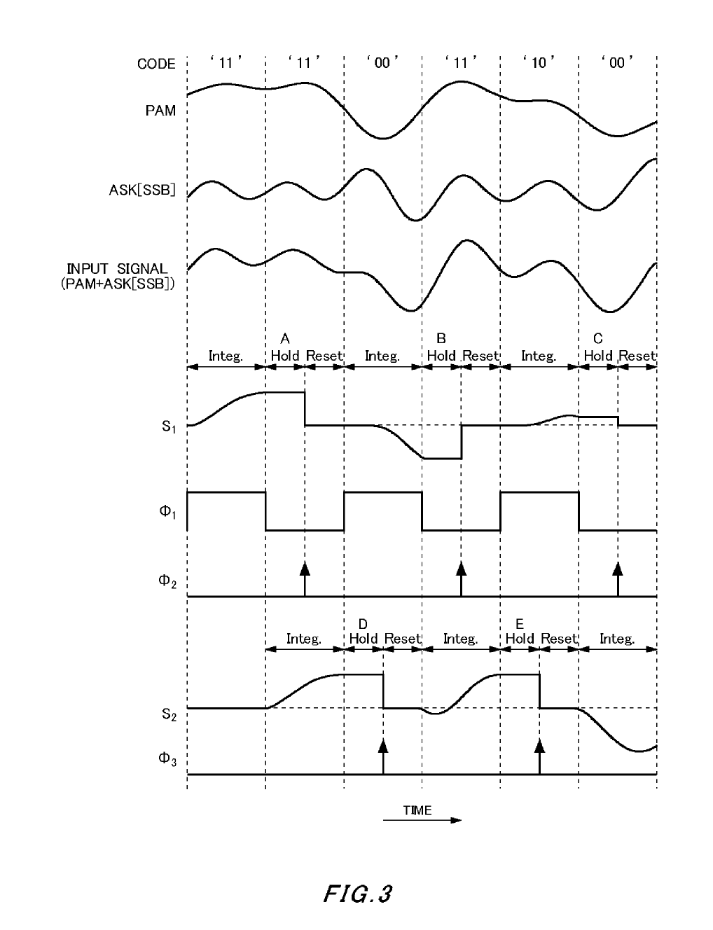

FIG. 3 illustrates, as an example, simulation results of the operations of the integrators included in the integrator section 600 relating to an embodiment of the present invention. In FIG. 3, the horizontal axis represents a relative timing and the vertical axis represents the current or voltage of a signal. In FIG. 3, the integrator section 600 receives an input signal corresponding to codes [11], [11], [00], [11], [10], and [00] and integrates the component of the pulse amplitude modulated signal. In this example, the integrator section 600 operates as the first integrator section 530.

The integrator section 600 receives an input signal generated by adding together a pulse amplitude modulated signal corresponding to codes [11], [11], [00], [11], [10], and [00], which is labeled as PAM in FIG. 3, and an amplitude shift keying modulated signal, which is labeled as ASK. The waveform labeled as “INPUT SIGNAL” in FIG. 3 is an exemplary waveform of the input signal. The signal labeled as “S₁” in FIG. 3 represents the output signal from the first integrator 630 and the signal labeled as “S₂” in FIG. 3 represents the output signal from the second integrator 632.

Furthermore, in FIG. 3, the signal labeled as “Φ₁” represents the control signal Φ₁ output from the switch controller section 660 to switch the first switch 620, the signal labeled as “Φ₂” represents the control signal Φ₂ output from the switch controller section 660 to switch the second switch 640, and the signal labeled as “Φ₃” represents the control signal Φ₃ output from the switch controller section 660 to switch the third switch 642. The switch controller section 660 may output, as the control signal Φ₁, a clock signal that repeatedly inverts at intervals of the symbol period T (=1/f0). In this case, the switch controller section 660 outputs, as the control signal Φ₄ to switch the fourth switch 650, the inverted version of the control signal Φ₁.

While the control signal Φ₁ takes logic 1, the first switch 620 connects together the voltage-current converter section 610 and the first integrator 630 to allow the first integrator 630 to integrate the input signal. This period is labeled as “Integ.” in the signal S₁ in FIG. 3. In the example shown in FIG. 3, since the first integrator 630 integrates the input signal over a duration equal to the symbol period T, the component of the amplitude shift keying modulated signal that has been amplitude shift keying modulated using the frequency signal f₀ having the same period as the symbol period T is averaged and becomes zero. In this way, the first integrator 630 can integrate the component of the pulse amplitude modulated signal.

Subsequently, when the control signal Φ₁ takes logic 0, the first switch 620 disconnects the voltage-current converter section 610 from the first integrator 630 to allow the first integrator 630 to retain the integrated signal. The first integrator 630 retains a value in proportion to an average amplitude value during one symbol. The switch controller section 660 outputs the control signal Φ₄, which is the inverted version of the control signal Φ₁, to connect the first integrator 630 to the output end of the integrator section 600 and to output the integrated signal to the pulse amplitude demodulator section 560. This period is labeled as “Hold” in the signal S₁ in FIG. 3.

Subsequently, the switch controller section 660 sends to the second switch 640 the control signal Φ₂ to turn on the second switch 640 to reset the first integrator 630. This period is labeled as “Reset” in the signal S₁ in FIG. 3.

As described above, the switch controller section 660 sends to the respective switches the control signals to allow the first integrator 630 to repeatedly perform the series of operations including “Integ.,” “Hold,” and “Reset” and to output an integrated signal at intervals of 2 T, which is double the symbol period T. In the example shown in FIG. 3, the first integrator 630 outputs an integrated signal corresponding to the input codes “11,” “00,” and “10” at intervals of 2 T during the “Hold” periods labeled as A, B and C in the signal S₁.

When the control signal Φ₁ takes logic 0, the first switch 620 disconnects the voltage-current converter section 610 from the first integrator 630, and, at the same time, connects the voltage-current converter section 610 to the second integrator 632. In other words, the second integrator 632 integrates the input signal over a duration equal to the symbol period T similarly to the first integrator 630. The second integrator 632 integrates the component of the pulse amplitude modulated signal similarly to the first integrator 630. This period is labeled as “Integ.” in the signal S₂ in FIG. 3.

Subsequently, when the control signal Φ₁ takes logic 1, the first switch 620 disconnects the voltage-current converter section 610 from the second integrator 632, and connects the voltage-current converter section 610 to the first integrator 630. Thus, the second integrator 632 retains the integrated signal. Furthermore, the switch controller section 660 outputs the control signal Φ₄, which is the inverted version of the control signal Φ₁, to connect the second integrator 632 to the output end of the integrator section 600 and thus to output the integrated signal to the pulse amplitude demodulator section 560. This period is labeled as “Hold” in the signal S₂ in FIG. 3.

Subsequently, the switch controller section 660 sends to the third switch 642 the control signal Φ₃ to turn on the third switch 642 to reset the second integrator 632. This period is labeled as “Reset” in the signal S₂ in FIG. 3.

As described above, the switch controller section 660 sends to the respective switches the control signals to allow the second integrator 632 to repeatedly perform the series of operations including “Integ.,” “Hold,” and “Reset” and to output an integrated signal at intervals of 2 T, which is double the symbol period T. In the example shown in FIG. 3, the second integrator 632 outputs an integrated signal corresponding to the input codes “11” and “11” at intervals of 2 T during the “Hold” periods labeled as D and E in the signal S₂.

As described above, the switch controller section 660 switches at every symbol period between the operations of integrating the input signals by the first integrator 630 and the second integrator 632 and the operations of retaining the integral values. Specifically speaking, the switch controller section 660 controls the first and second integrators 630 and 632 in such a manner that, while the first integrator 630 integrates the input signal, the second integrator 632 retains the integral value. Likewise, the switch controller section 660 controls the first and second integrators 630 and 632 in such a manner that, while the first integrator 630 retains the integral value, the second integrator 632 integrates the input signal.

Furthermore, the switch controller section 660 controls the first and second integrators 630 and 632 in such a manner that the first integrator 630 is connected to the output end of the integrator section 600 while the first integrator 630 retains the integral value, and the second integrator 632 is connected to the output end of the integrator section 600 while the second integrator 632 retains the integral value. In this way, the integrator section 600 can output the integrated data from the output end thereof while integrating the input signal over a duration substantially the same as the symbol period at every symbol period.

In the above-described example, the first and second integrators 630 and 632 integrate the input signals over a duration equal to the symbol period T. Alternatively, the first and second integrators 630 and 632 may integrate the input signals over a duration shorter than the symbol period T. In this case, the first frequency signal output section 120 preferably outputs a frequency signal a period of which is substantially the same as the duration over which the first and second integrators 630 and 632 integrate the input signals or a period of which is equal to a fraction of 1/n of the duration over which the first and second integrators 630 and 632 integrate the input signals.

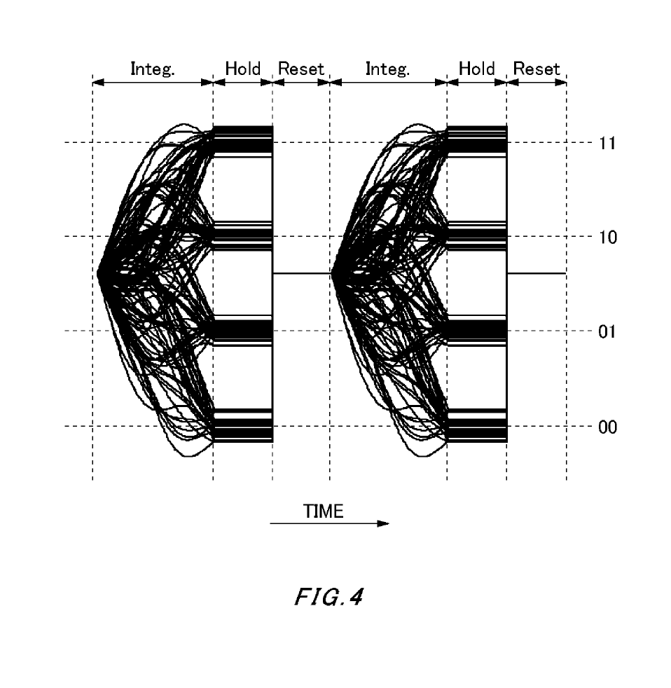

FIG. 4 is an eye diagram showing simulation results of the output signals from the integrators included in the integrator section 600 relating to an embodiment of the present invention. In FIG. 4, the horizontal axis represents a relative timing, and the vertical axis represents the current or voltage of a signal. The simulation was performed assuming that, for example, the integrator section 600 integrated a signal obtained by adding together a pulse amplitude modulated signal and an amplitude shift keying modulated signal, which is mapped by four codes represented by a 2-bit pseudo-random bit sequence.

The eye diagram shown in FIG. 4 was obtained by allowing the integrators included in the integrator section 600 to perform two sequences of the “Integ.” “Hold” and “Reset” operations multiple times and overlaying the simulation results of the output signal over the same coordinates. The simulation results indicate that the signals corresponding to the codes [00], [01], [10], and [11] are separately output during the “Hold” periods. Consequently, it has been proved that the pulse amplitude demodulation can be successfully performed.

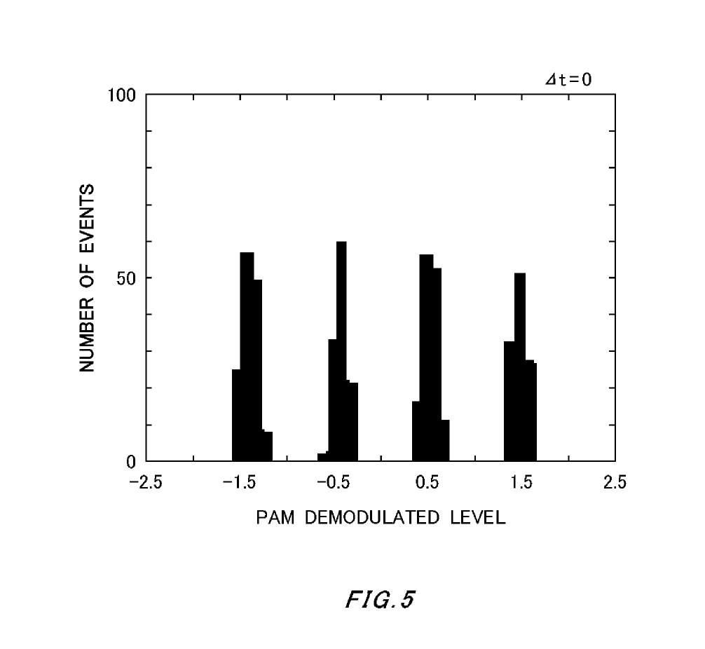

FIG. 5 illustrates, as an example, simulation results of data transmission and reception using OFDM. In this example, an OFDM demodulator demodulates a 4-PAM pulse amplitude modulated signal into levels such as −1.5 V, −0.5 V, 0.5 V, and 1.5 V.

In FIG. 5, the horizontal axis represents the level that is obtained as a result of the demodulation, and the vertical axis represents the number of events, which is the number of times at which each level is obtained as a result of the demodulation. Thus, FIG. 5 is a histogram of levels. FIG. 5 shows, as an example, the results of a simulation where the sampling timing of the analog/digital converter is not different from expectation and the respective levels are successfully demodulated.

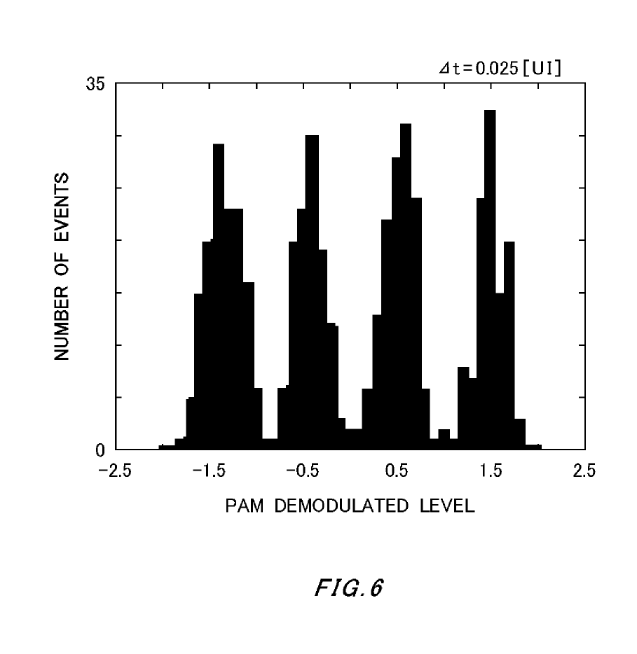

FIG. 6 illustrates, as an example, simulation results of data transmission and reception using OFDM when the receiving timing is different from expectation. In this example, a simulation was performed under conditions such that, when the symbol period T is 1 UI, the sampling timing of the analog/digital converter is different from expectation by 0.025 UI. The simulation was performed under the same conditions as the simulation described with reference to FIG. 5 other than the sampling timing. FIG. 6 shows that the distribution of the histogram of levels became wider in terms of both the number of events and the levels. This indicates that the timing variation causes variation in demodulated results in an OFDM demodulator.

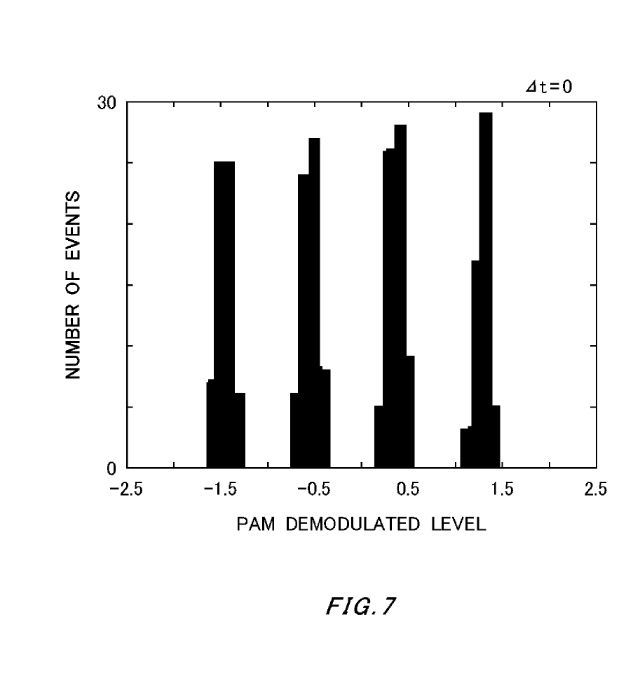

FIG. 7 illustrates, as an example, simulation results of data transmission and reception using the transmitting system 100 and the receiving system 500 relating to an embodiment of the present invention. FIG. 7 shows, as an example, results of a simulation where the receiving system 500 demodulates a 4-PAM pulse amplitude modulated signal into levels such as −1.5 V, −0.5 V, 0.5 V and 1.5 V.

In FIG. 7, the horizontal axis represents the level that is obtained as a result of the demodulation, and the vertical axis represents the number of events, which is the number of times at which each level is obtained as a result of the demodulation. Thus, FIG. 7 is a histogram of levels. FIG. 7 shows, as an example, the results of a simulation where the sampling timing of the analog/digital converter is not different from expectation and the respective levels are successfully demodulated.

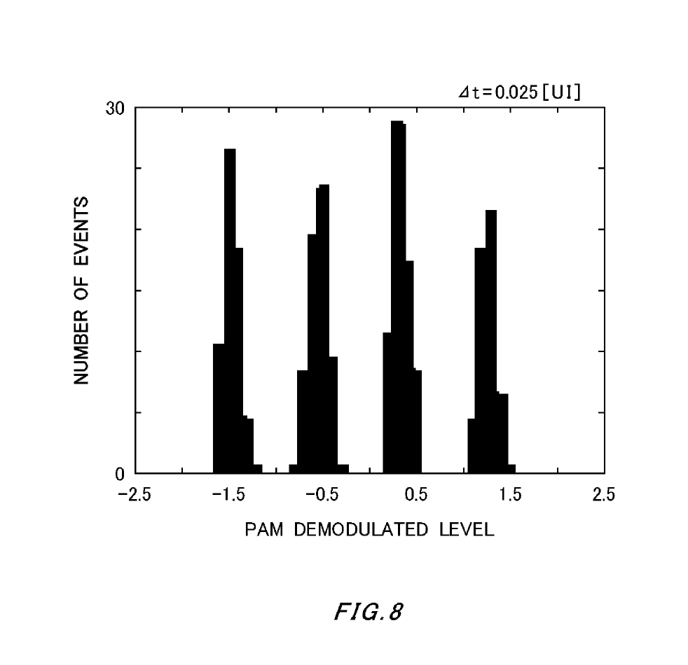

FIG. 8 illustrates, as an example, simulation results of data transmission and reception using the transmitting system 100 and the receiving system 500 relating to an embodiment of the present invention when the receiving timing is different from expectation. In this example, a simulation was performed under conditions such that, when the symbol period T is 1 UI, the sampling timing of the analog/digital converter is different from expectation by 0.025 UI. The simulation was performed under the same conditions as the simulation described with reference to FIG. 7 other than the sampling timing. FIG. 8 shows that the distribution of the histogram of levels is substantially the same as that shown in FIG. 7. This indicates that the receiving system 500 can reduce the influence of timing variation on the demodulated results when compared with OFDM.

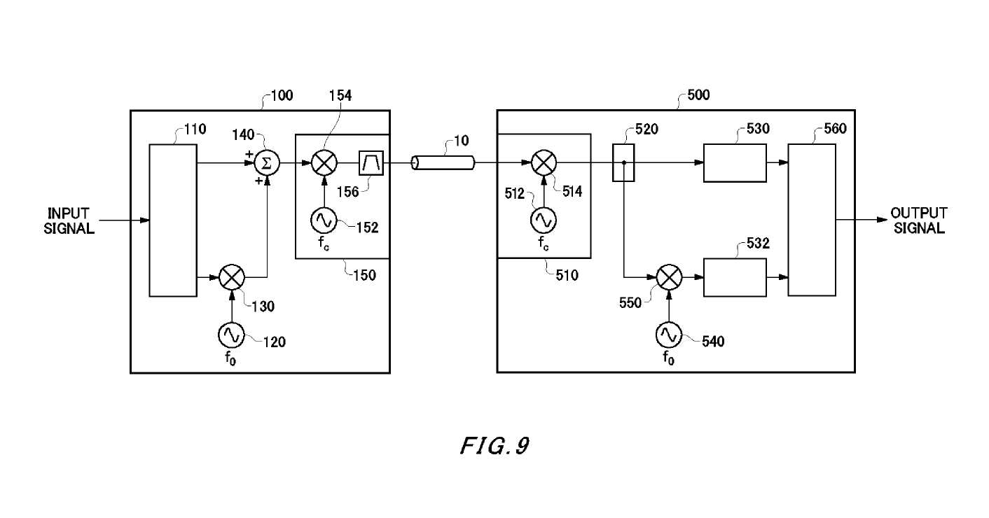

FIG. 9 illustrates a first modification example of the transmitting system 100 and the receiving system 500 relating to the embodiment of the present invention, together with the transfer line 10. In the following description of the first modification example, some of the operations of the transmitting system 100 and the receiving system 500 are substantially the same as the corresponding operations of the transmitting system 100 and the receiving system 500 according to the embodiment shown in FIG. 1, and thus assigned with the same reference numerals and not explained here. According to the first modification example, the transmitting system 100 up-converts the transmission signal and transmits the up-converted transmission signal, and the receiving system 500 down-converts the received signal and then demodulates the down-converted signal.

The transmitter section 150 includes a second frequency signal output section 152, an up-converter section 154, and a filter section 156. The second frequency signal output section 152 outputs a second frequency signal. The second frequency signal output section 152 may output a high-frequency frequency signal whose frequency may range from several hundred MHz to several GHz.

The up-converter section 154 is connected to the adder section 140 and the second frequency signal output section 152, and up-converts the transmission signal by adding the frequency of the second frequency signal and transmits the up-converted transmission signal. The up-converter section 154 may include a mixer. The up-converter section 154 may multiplex the transmission signal, which serves as a baseband signal, onto the second frequency signal f_{c}, which serves as a carrier wave, and transmit the resulting signal.

The filter section 156 allows a signal band to pass that is obtained by shifting the signal band of the transmission signal by adding the frequency f_{c} of the second frequency signal to the signal band of the transmission signal. The filter section 156 may be a band pass filter that may allow a band from the carrier wave frequency f_{c} to the frequency f_{c+} f₀ to pass. Alternatively or additionally, the filter section 156 may include a low pass filter that allows a signal having a frequency equal to or shorter than the frequency f_{c+} f₀ to pass. Alternatively or additionally, the filter section 156 may include a high pass filter that allows a signal having a frequency equal to or longer than the frequency f_{c} to pass.

The receiver section 510 receives a signal that has been transmitted from the transmitting system 100. The received signal has been generated by up-converting the transmission signal by adding the frequency f_{c} of the second frequency signal to the transmission signal. The receiver section 510 includes a frequency signal output section 512 and a down-converter section 514. The frequency signal output section 512 outputs a frequency signal having a frequency substantially the same as the frequency f_{c} of the second frequency signal.

The down-converter section 514 down-converts the reception signal by using the frequency signal having substantially the same frequency as the second frequency signal, specifically speaking, by subtracting a frequency substantially the same as the frequency of the second frequency signal from the frequency of the reception signal. The down-converter section 514 may include a mixer.

The down-converter section 514 may convert the reception signal into the baseband signal by shifting the signal band of the reception signal to the signal band of the baseband signal by the second frequency f_{c}. The resulting baseband signal is equivalent to a signal obtained by adding together the amplitude shift keying modulated signal output from the first amplitude shift keying modulator section 130 and the second pulse amplitude modulated signal output from the pulse amplitude modulator section 110. Thus, the receiving system 500 can demodulate the reception signal in the manner descried with reference to FIGS. 1 to 3.

The receiver section 510 may further include a filter section that, before the reception signal is input into the down-converter section 514, allows a signal band to pass that is obtained by shifting the signal band of the transmission signal by adding the frequency f_{c} of the second frequency signal to the signal band of the transmission signal. The filter section may be substantially the same as the filter section 156 included in the transmitter section 150.

According to the first modification example of the transmitting system 100 and the receiving system 500 relating to the present embodiment described above, the transmission signal can be multiplexed onto a carrier wave and the resulting signal can be transmitted. Therefore, high-speed data communication can be realized using a simple configuration with the use of a predetermined limited communication frequency band. The transmitting system 100 and the receiving system 500 relating to the present embodiment may transmit the transmission signal using the transfer line 10, but may alternatively transmit the transmission signal in a wireless manner. If such is the case, the transmitter section 150 includes a transmission antenna and the receiver section 510 includes a reception antenna.

In the above-described exemplary embodiment, the receiving system 500 includes the frequency signal output section 512 that outputs a frequency substantially the same as the frequency of the second frequency signal. Here, the transmitting system 100 may transmit the second frequency signal to the receiving system 500 in advance, and the frequency signal output section 512 may output a frequency substantially the same as the frequency of the second frequency signal in synchronization with the received second frequency signal.

Alternatively, the receiving system 500 may receive the second frequency signal from the transmitting system 100 using a different transfer line than the transfer line 10. Stated differently, the down-converter section 514 receives the second frequency signal from the transmitting system 100 and down-converts the received second frequency signal. In this way, the receiving system 500 may be realized without the frequency signal output section 512.

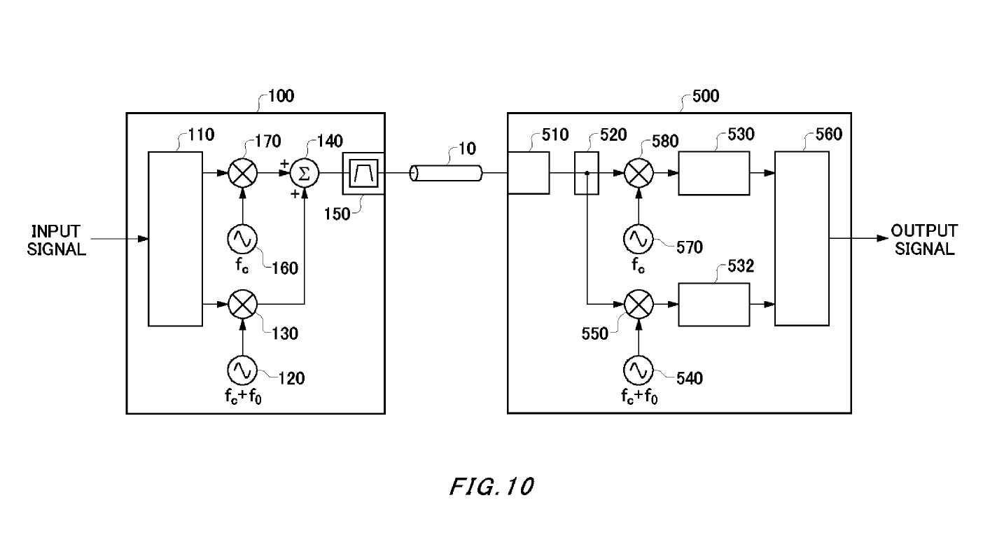

FIG. 10 illustrates a second modification example of the transmitting system 100 and the receiving system 500 relating to the embodiment of the present invention, together with the transfer line 10. In the following description of the second modification example, some of the operations of the transmitting system 100 and the receiving system 500 are substantially the same as the corresponding operations of the transmitting system 100 and the receiving system 500 according to the embodiment shown in FIG. 1, and thus assigned with the same reference numerals and not explained here.

The transmitting system 100 includes a second frequency signal output section 160, a second amplitude shift keying modulator section 170. The second frequency signal output section 160 outputs a second frequency signal. The second frequency signal output section 160 may output a high-frequency frequency signal whose frequency ranges from several hundred MHz to several GHz.

The second amplitude shift keying modulator section 170 is connected to the pulse amplitude modulator section 110 and the second frequency signal output section 160, and amplitude shift keying modulates the second pulse amplitude modulated signal using the second frequency signal into a second amplitude shift keying modulated signal. The second amplitude shift keying modulator section 170 may include a mixer. The second amplitude shift keying modulator section 170 may multiplex the second pulse amplitude modulated signal onto a carrier wave having the second frequency f_{c} and transmit the resulting signal.

The first frequency signal output section 120 outputs a third frequency signal having a frequency f_{c+} f₀ generated by adding the frequency f_{c} of the second frequency signal to the frequency f₀ of the first frequency signal. Thus, the first amplitude shift keying modulator section 130 performs amplitude shift keying modulation using the third frequency signal to generate a first amplitude shift keying modulated signal, and the adder section 140 adds together the first amplitude shift keying modulated signal and the second amplitude shift keying modulated signal to generate a transmission signal.

The transmitter section 150 may include a filter section. The filter section may be a band pass filter that allows the band ranging from the carrier wave frequency f_{c} to f_{c+} f₀ to pass. Alternatively or additionally, the filter section 156 may include a low pass filter that allows a signal having a frequency equal to or shorter than the frequency f_{c+} f₀ to pass. Alternatively or additionally, the filter section 156 may include a high pass filter that allows a signal having a frequency equal to or longer than the frequency f_{c} to pass.

The receiver section 510 receives a transmitted signal that is obtained by adding together a frequency shift keying modulated signal that has been modulated using the third frequency signal having a frequency equal to the sum of the frequency of the first frequency signal and the frequency of the second frequency signal and a frequency shift keying modulated signal that has been modulated by using the second frequency signal. The receiving system 500 includes a frequency signal output section 570 and a second amplitude shift keying demodulator section 580. The frequency signal output section 570 outputs a frequency signal having a frequency substantially the same as the frequency f_{c} of the second frequency signal.

The second amplitude shift keying demodulator section 580 is connected between one of the branches provided by the divider section 520 and the first integrator section 530, and amplitude shift keying demodulates the reception signal using a frequency signal having a frequency substantially the same as the frequency f_{c} of the second frequency signal. The second amplitude shift keying demodulator section 580 may include a mixer.

The second amplitude shift keying demodulator section 580 shifts the signal band of the reception signal by the second frequency f_{c} and inputs into the first integrator section 530 a signal obtained by adding together the second pulse amplitude modulated signal and the amplitude shift keying modulated signal that has been amplitude shift keying modulated using the first frequency signal. Thus, the first integrator section 530 can integrate the reception signal obtained by adding together the amplitude shift keying modulated signal and the second pulse amplitude modulated signal over a duration equal to the symbol period and can output the integral value of the second pulse amplitude modulated signal as described above with reference to FIGS. 1 to 3.

The first amplitude shift keying demodulator section 550 amplitude shift keying demodulates the reception signal using a frequency signal having a frequency substantially the same as the frequency f_{c+} f₀, which is obtained by adding the frequency f_{c} of the second frequency signal to the frequency f₀ of the first frequency signal. The first amplitude shift keying demodulator section 550 shifts the signal band of the reception signal by the third frequency f_{c+} f₀ and thus inputs into the second integrator section 532 a signal obtained by adding together the first pulse amplitude modulated signal and the modulated signal obtained by modulating the second pulse amplitude modulated signal using the first frequency signal.

Thus, the second integrator section 532 can integrate the reception signal over a duration equal to the symbol period and output the integral value of the first pulse amplitude modulated signal as described above with reference to FIG. 1. The receiver section 510 may further include a filter section. The filter section may include substantially the same filter as the filter of the filter section of the transmitter section 150.

According to the second modification example of the transmitting system 100 and the receiving system 500 relating to the present embodiment described above, the transmission signal can be multiplexed onto a carrier wave f_{c} and the resulting signal can be transmitted. Therefore, high-speed data communication can be realized using a simple configuration with the use of a predetermined limited communication frequency band. The transmitting system 100 and the receiving system 500 relating to the present embodiment may transmit the transmission signal using the transfer line 10, but may alternatively transmit the transmission signal in a wireless manner. If such is the case, the transmitter section 150 includes a transmission antenna and the receiver section 510 includes a reception antenna.

In the above-described exemplary embodiment, the receiving system 500 includes the frequency signal output section 570 that outputs a frequency substantially the same as the frequency f_{c} of the second frequency signal. Here, the transmitting system 100 may transmit the second frequency signal to the receiving system 500 in advance, and the frequency signal output section 570 may output a frequency f_{c} substantially the same as the frequency of the second frequency signal in synchronization with the received second frequency signal.

Alternatively, the receiving system 500 may receive the second frequency signal from the transmitting system 100 using a different transfer line than the transfer line 10. Stated differently, the second amplitude shift keying demodulator section 580 receives the second frequency signal from the transmitting system 100 and performs amplitude shift keying demodulation using the received second frequency signal. In this way, the receiving system 500 may be realized without the frequency signal output section 570.

In this case, the receiving system 500 may also receive the third frequency signal from the transmitting system 100 using a different transfer line than the transfer line 10. The first amplitude shift keying demodulator section 550 performs amplitude shift keying demodulation using a signal having a frequency f_{c+} f₀, which is output from the first frequency signal output section 120 and is obtained by adding the frequency of the second frequency signal to the frequency of the first frequency signal. In this way, the receiving system 500 may be realized without the frequency signal output section 540.

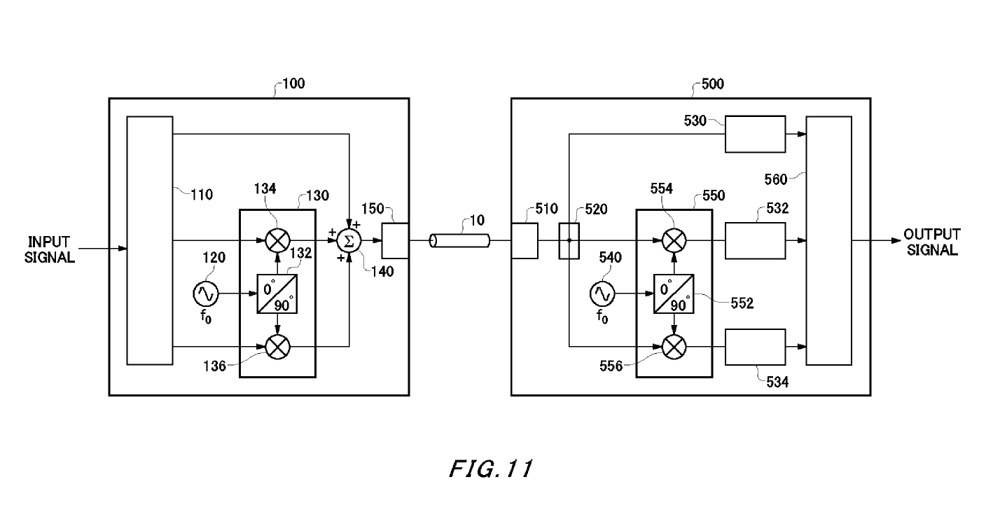

FIG. 11 illustrates a third modification example of the transmitting system 100 and the receiving system 500 relating to the embodiment of the present invention, together with the transfer line 10. In the following description of the third modification example, some of the operations of the transmitting system 100 and the receiving system 500 are substantially the same as the corresponding operations of the transmitting system 100 and the receiving system 500 according to the embodiment shown in FIG. 1, and thus assigned with the same reference numerals and not explained here.

The pulse amplitude modulator section 110 pulse amplitude modulates the input signal into a set of first, second and third pulse amplitude modulated signals. The pulse amplitude modulator section 110 may first divide one or two input signals into three signals at every predetermined bit length and then pulse amplitude modulate the three signals into three pulse amplitude modulated signals. Alternatively, the pulse amplitude modulator section 110 may pulse amplitude modulate three different input signals into three different pulse amplitude modulated signals.

The first amplitude shift keying modulator section 130 relating to the present modification example quadrature phase amplitude modulates the first and third pulse amplitude modulated signals using signals that have the same frequency as the first frequency signal and are orthogonal to each other. The first amplitude shift keying modulator section 130 includes a phase shifter section 132, a first mixer 134, and a second mixer 136.

The phase shifter section 132 is connected to the first frequency signal output section 120 and outputs two frequency signals that have the same frequency as the frequency f₀ of the first frequency signal and have phases orthogonal to each other. For example, the phase shifter section 132 divides the input frequency signal into two signals, output one of the signals without modification, and delays the phase of the other signal by 90 degrees and outputs the result. The phase shifter section 132 may include a delay element and the like corresponding to the frequency f₀ of the input frequency signal.

The first mixer 134 is connected to the pulse amplitude modulator section 110 and the phase shifter section 132 and frequency modulates the first pulse amplitude modulated signal using the first frequency signal. The second mixer 136 is connected to the pulse amplitude modulator section 110 and the phase shifter section 132, and frequency modulates the third pulse amplitude modulated signal using a frequency signal the phase of which is 90-degree delayed when compared with the phase of the first frequency signal used by the first mixer 134.

In this way, the first amplitude shift keying modulator section 130 relating to the third modification example quadrature phase amplitude modulates the first and third pulse amplitude modulated signals and sends the two modulated signals to the adder section 140. The adder section 140 adds together the quadrature phase amplitude modulated signals and the second pulse amplitude modulated signal to generate the transmission signal. The transmitter section 150 transmits the transmission signal to the receiving system 500. The receiving system 500 additionally includes a third integrator section 534 having substantially the same configurations as the second integrator section.

The receiver section 510 receives the signal that is obtained by the transmitting system 100 by adding together the pulse amplitude modulated signal and the signals obtained by quadrature phase amplitude modulating the pulse amplitude modulated signals and that is transmitted from the transmitting system 100. The first integrator section 530 is connected to one of the branches provided by the divider section 520, integrates the reception signal over a duration substantially the same as the symbol period, with which the pulse amplitude modulator section 110 performs pulse amplitude modulation, at every symbol period, and thus obtains the pulse amplitude modulated signal.

Since the modulation frequency f₀ of the quadrature phase amplitude modulated signal components included in the reception signal is substantially the same as the symbol rate or a constant multiple of the symbol rate, the first integrator section 530 can average the signal components by integrating the reception signal over a duration substantially the same as the symbol period at every symbol period, so that the signal components become zero. Thus, the first integrator section 530 can output the integral value of the second pulse amplitude modulated signal as discussed above with reference to FIGS. 1 to 3.

The divider section 520 divides the other of the two branches into two additional branches. The first amplitude shift keying demodulator section 550 of the present third modification example receives the reception signals from the additional two branches provided by the divider section 520, and quadrature phase amplitude demodulate the reception signals using signals that are substantially the same as the first frequency signal and are orthogonal to each other. The first amplitude shift keying demodulator section 550 includes a phase shifter section 552, a third mixer 554 and a fourth mixer 556.

The phase shifter section 552 is connected to the frequency signal output section 540 and outputs two frequency signals that have a frequency substantially the same as the frequency f₀ of the first frequency signal and have phases orthogonal to each other. The phase shifter section 552 divides the input frequency signal into two signals, output one of the signals without modification, and delays the phase of the other signal by 90 degrees and outputs the result. The phase shifter section 552 may include a delay element and the like corresponding to the frequency f₀ of the input frequency signal.

The third mixer 554 is connected to the divider section 520 and the phase shifter section 552 and frequency demodulates the reception signal using the first frequency signal. The fourth mixer 556 is connected to the divider section 520 and the phase shifter section 552, and frequency demodulates the reception signal using a frequency signal the phase of which is 90-degree delayed when compared with the phase of the first frequency signal used by the third mixer 554. The second and third integrator sections 532 and 534 respectively receive and integrate the demodulated signals.

In this way, the first amplitude shift keying demodulator section 550 relating to the third modification example quadrature phase amplitude demodulates the reception signals, and the demodulated signals contain the signal component obtained by mixing the component of the second pulse amplitude modulated signal and the first frequency signal output from the frequency signal output section 540. Since the frequency of the first frequency signal output from the frequency signal output section 540 is substantially the same as the symbol rate or a constant multiple of the symbol rate, the second and third integrator sections 532 and 534 can average the signal component by integrating the demodulated signals over a duration substantially the same as the symbol period at every symbol period, so that the signal component becomes zero.

Thus, the second and third integrator sections 532 and 534 can output the integral values of the first and third pulse amplitude modulated signals as described above with reference to FIG. 1. According to the third modification example of the transmitting system 100 and the receiving system 500 relating to the present embodiment, the signal obtained by adding together the pulse amplitude modulated signal and the quadrature phase amplitude modulated signal can be transmitted and received. In this way, high-speed data communication can be realized with a simple configuration using a limited communication band.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A transmitting system comprising:
a pulse amplitude modulator section that pulse amplitude modulates an input signal into a set of first and second pulse amplitude modulated signals;
a first frequency signal output section that outputs a first frequency signal;
a first amplitude shift keying modulator section that amplitude shift keying modulates, using the first frequency signal, the first pulse amplitude modulated signal into an amplitude shift keying modulated signal; and
an adder section that adds together the amplitude shift keying modulated signal and the second pulse amplitude modulated signal to generate a transmission signal.

2. The transmitting system as set forth in claim 1, further comprising
a low pass filter that allows a signal band of the transmission signal to pass.

3. The transmitting system as set forth in claim 1, further comprising a transmitter section that includes:
a second frequency signal output section that outputs a second frequency signal; and
an up-converter section that up-converts the transmission signal by adding a frequency of the second frequency signal to the transmission signal and transmits the resulting transmission signal.

4. The transmitting system as set forth in claim 3, wherein
the transmitter section further includes a band pass filter that allows a signal band to pass that is obtained by shifting the signal band of the transmission signal through addition of the frequency of the second frequency signal to the signal band of the transmission signal.

5. The transmitting system as set forth in claim 1, further comprising:
a second frequency signal output section that outputs a second frequency signal;
a second amplitude shift keying modulator section that amplitude shift keying modulates the second pulse amplitude modulated signal using the second frequency signal into a second amplitude shift keying modulated signal; and
a band pass filter that allows a signal band to pass that is obtained by shifting a signal band of the transmission signal through addition of a frequency of the second frequency signal to the transmission signal, wherein
the first frequency signal output section outputs a third frequency signal having a frequency equal to a sum of the frequency of the first frequency signal and the frequency of the second frequency signal,
the first amplitude shift keying modulator section uses the third frequency signal to amplitude shift keying modulate the first pulse amplitude modulated signal into a first amplitude shift keying modulated signal,
the adder section adds together the first amplitude shift keying modulated signal and the second amplitude shift keying modulated signal to generate a transmission signal, and
the band pass filter allows the transmission signal generated by the adder section to pass.

6. The transmitting system as set forth in claim 1, wherein
the pulse amplitude modulator section pulse amplitude modulates the input signal into a set of first, second and third pulse amplitude modulated signals,
the first amplitude shift keying modulator section uses signals that have the same frequency as the first frequency signal and are orthogonal to each other to quadrature phase amplitude modulate the first and third pulse amplitude modulated signals, and
the adder section adds together the quadrature phase amplitude modulated signals and the second pulse amplitude modulated signal to generate a transmission signal.

7. A receiving system comprising:
a receiver section that receives a transmission signal transmitted by the transmitting system as set forth in claim 1;
a divider section that divides a transfer path to transfer a reception signal received by the receiver section into two branches;
a first integrator section that is connected to one of the branches provided by the divider section and integrates, to generate a pulse amplitude modulated signal, the reception signal over a predetermined duration at every symbol period with which the pulse amplitude modulator section performs the pulse amplitude modulation;
a first amplitude shift keying demodulator section that is connected to the other of the branches provided by the divider section and amplitude shift keying demodulates the reception signal using a signal having substantially the same frequency as the first frequency signal into a demodulated signal;
a second integrator section that is connected to the first amplitude shift keying demodulator section and integrates the demodulated signal over a predetermined duration at every symbol period to generate a pulse amplitude modulated signal; and
a pulse amplitude demodulator section that is connected to the first and second integrator sections and receives and pulse amplitude demodulates the pulse amplitude modulated signals respectively output from the first and second integrator sections.

8. The receiving system as set forth in claim 7, wherein
the first amplitude shift keying demodulator section performs the amplitude shift keying demodulation using the first frequency signal output from the first frequency signal output section.

9. The receiving system as set forth in claim 7, wherein
the first and second integrator sections integrate the reception signal and the demodulated signal over a duration substantially the same as the symbol period.

10. The receiving system as set forth in claim 7, wherein
the receiver section:
receives a reception signal that is transmitted from the transmitting system and obtained by up-converting the transmission signal by adding a frequency of a second frequency signal; and
includes a down-converter section that down-converts the reception signal by subtracting a frequency substantially the same as the frequency of the second frequency signal, using a frequency signal having substantially the same frequency as the second frequency signal.

11. The receiving system as set forth in claim 10, wherein
the down-converter section receives the second frequency signal from the transmitting system and performs the down-conversion using the received second frequency signal.

12. The receiving system as set forth in claim 7, wherein
the receiver section receives a reception signal that is obtained and transmitted by the transmitting system by adding together (i) a modulated signal that is frequency shift keying modulated using a signal having a frequency equal to a sum of the frequency of the first frequency signal and a frequency of a second frequency signal and (ii) a modulated signal that has been frequency shift keying modulated using the second frequency signal,
the receiving system further comprises:
a second amplitude shift keying demodulator section that is connected between the first integrator section and one of the branches provided by the divider section and amplitude shift keying demodulates the reception signal using a frequency signal having substantially the same frequency as the second frequency signal, and
the first amplitude shift keying demodulator section amplitude shift keying demodulates the reception signal using a frequency signal having a frequency substantially the same as a sum of the frequency of the first frequency signal and the frequency of the second frequency signal.

13. The receiving system as set forth in claim 12, wherein
the second amplitude shift keying demodulator section receives the second frequency signal from the transmitting system and performs the amplitude shift keying demodulation using the received second frequency signal, and
the first amplitude shift keying demodulator section performs the amplitude shift keying demodulation using a signal having a frequency equal to a sum of the frequency of the second frequency signal and the frequency of the first frequency signal output from the first frequency signal output section.

14. The receiving system as set forth in claim 7, further comprising
a third integrator section that has substantially the same configuration as the second integrator section, wherein
the receiver section receives a reception signal that is obtained and transmitted by the transmitting system by adding together a pulse amplitude modulated signal and signals obtained by quadrature phase amplitude modulating pulse amplitude modulated signals,
the divider section divides the other of the branches into two additional branches,
the first amplitude shift keying demodulator section receives reception signals from the additional branches provided by the divider section and quadrature phase amplitude demodulates the received reception signals, and
the second and third integrator sections respectively receive two demodulated signals that are demodulated by the first amplitude shift keying demodulator section, and integrate the received signals over a predetermined duration at every symbol period with which the pulse amplitude modulator section performs the pulse amplitude modulation, to generate pulse amplitude modulated signals.

15. The receiving system as set forth in claim 7, wherein
the first and second integrator sections each include two or more integrators,
each of the integrators is switched between an operation of integrating an input signal and an operation of retaining an integral value at every symbol period, and
while one of the integrators integrates the input signal, the other one or more integrators retain the integral value.

16. A transmitting method comprising:
pulse amplitude modulating an input signal into a set of first and second pulse amplitude modulated signals;
outputting a first frequency signal;
amplitude shift keying modulating, using the first frequency signal, the first pulse amplitude modulated signal into an amplitude shift keying modulated signal;
adding together the amplitude shift keying modulated signal and the second pulse amplitude modulated signal to generate a transmission signal; and
transmitting the transmission signal.

17. A receiving method comprising:
receiving a transmission signal transmitted by the transmitting method as set forth in claim 16;
dividing a transfer path to transfer a reception signal received in the receiving into two branches;
integrating, to generate a pulse amplitude modulated signal, the reception signal over a predetermined duration at every symbol period with which the pulse amplitude modulation is performed, by using a first integrator section that is connected to one of the branches provided by the dividing;
amplitude shift keying demodulating the reception signal using a signal having substantially the same frequency as the first frequency signal into a demodulated signal, by using a first amplitude shift keying demodulator section that is connected to the other of the branches provided by the dividing;
integrating the demodulated signal over a predetermined duration at every symbol period to generate a pulse amplitude modulated signal, by using a second integrator section; and
receiving and pulse amplitude demodulating the pulse amplitude modulated signals respectively output from the first and second integrator sections.
